(19) United States
(12) Patent Application Publication
(10) Pub. No.: US 2009/0097939 A1
(43) Pub. Date: Apr. 16, 2009

(54) Fastening element

(75) Inventor: Thomas Ayrle, Langerringen (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/287,446

(22) Filed: Oct. 8, 2008

(30) Foreign Application Priority Data
Oct. 12, 2007 (DE) 10 2007 000 859.9

(51) Int. Cl. F16B 13/06

(52) U.S. Cl. 411/57.1

(57) ABSTRACT

A fastening element for being anchored in a borehole of a constructional component has an expansion sleeve (21) surrounding the shaft (12) of the fastening element (11) and having a plurality of expansion tabs (23) spaced from each other by elongate slots (25) extending from a free end (24) of the expansion sleeve (21) over at least a half of a longitudinal extent (L) of the expansion sleeve (21) and having at least one bead (26) a longitudinal extent (F) of which corresponds to at least a half of a longitudinal extent (G) of the elongate slot (25). The shaft (12) has an expansion portion for widening the expansion sleeve (21).

### BACKGROUND OF THE INVENTION

1. Field of the Invention

The present invention relates to a fastening element for being anchored in a borehole of a constructional component, including a shaft having, at its first end region engagement means, and an expansion sleeve surrounding the shaft and having a plurality of expansion tabs spaced from each other by elongate slots extending from a free end of the expansion sleeve over at least a half of a longitudinal extent of the expansion sleeve, with the shaft having, in its second end region opposite the first end region, an expansion portion for widening the expansion sleeve and including a conical section widening toward a free end of the second end region of the shaft.

2. Description of the Prior Art

Fastening elements of the type described above are called, e.g., stud or segment anchors and are formed in an economically advantageous form as sheet metal sleeve anchors. The fastening elements are driven into a constructional component through a through-opening of a component which has to be secured on the constructional component.

A fastening element of the above-described type is disclosed in a German Patent No. 636,609. With elongate expansion tabs extending along the longitudinal extent of the expansion sleeve, an advantageous widening of the expansion region and, thus, an adequate frictional connection for anchoring of the fastening element in the constructional component is insured. The diameter of a bore, which is formed in the constructional component, and of the through-opening of the attachment component are defined by the outer diameter of the sleeve.

The drawback of the known fastening element consists in that costs associated with the formation of boreholes are noticeably increased from one diameter to another.

It is also known to use expansion sleeves having a small wall thickness, so that a fastening element with a shaft diameter, e.g., of 10 mm, can be set in a borehole having a diameter of 12 mm. For an adequate settability, the material or wall thickness of expansion sleeve lies in a range from 0.6 to 0.9 mm. When fastening element with such a sleeve is driven in a borehole, the expansion sleeve can become deformed during a setting process, which causes problems during the setting process and leads, as the case may be, to malfunction of the fastening element.

In order to provide fastening elements with expansion sleeves having a relatively large wall thickness, German Publication DE 35 08 015 A1 suggests, e.g., to reduce the diameter of the shaft in a region adjacent to the shaft expansion portion and mount the expansion sleeve in this region.

The drawback of the solution of DE 35 08 015 A1 consists in that the useful cross-section of the shaft in the sleeve region is reduced, and additional operational steps for narrowing the shaft cross-section are necessary.

An object of the present invention is to provide a fastening element with an expansion sleeve having a small wall thickness, and which is simple to produce and easy to set in.

### SUMMARY OF THE INVENTION

This and other objects of the present invention, which will become apparent hereinafter, are achieved by providing a fastening element with an expansion sleeve the expansion tabs of which have at least one bead a longitudinal extent which corresponds to at least a half of a longitudinal extent of an elongate slot that separates adjacent expansion tabs.

With a bead extending toward the longitudinal axis of the fastening element, the geometrical inertia moment of the cross-section of the expansion sleeve in the expansion region is increased, whereby the flexural strength of the expansion tabs likewise increases. The danger of the deformation of the expansion tabs during the setting of the fastening element in a borehole is noticeably reduced despite the use of an expansion sleeve with a small material or wall thickness. As a result of the expansion sleeve having long and thin expansion tabs, an adequate friction of the fastening element in the constructional component in the tensioned condition is insured. Thereby, the settability of the fastening element in narrow boreholes or in a high-strength constructional components is insured. In addition, due the rigidity of the expansion sleeve, high holding value is obtainable even in low-strength constructional components.

Advantageously, the at least bead widens the expansion sleeve circumferentially. Thereby, the outer diameter of the expansion sleeve in the sleeve non-tensioned condition is increased at least in one region by the bead. During driving of the fastening element into a borehole, the at least one bead engages the borehole wall and presses a corresponding expansion tab onto the shaft or the expansion portion of the shaft. As a result, the free end of the respective expansion tab does not remain on the borehole rims during the driving-in process, and the expansion tab does not become deformed before start of the setting process.

Advantageously, the end of the at least one bead adjacent to an end of respective elongate slot is spaced from the adjacent end of the elongate slot in the direction of opening of the elongate slot at the free end of the expansion sleeve to provide for the opening of the slot at the expansion sleeve free end. The increase of the rigidity of the expansion tab takes place simply in the region adjacent to the free end of the expansion sleeve up to a rear section, whereby the remaining region forms an advantageous bendable link for the expansion tab during expansion of the expansion sleeve, without reinforcing the expansion tabs.

Advantageously, at least one rotation-preventing element is provided in an axial projection of the at least one bead. The rotation-preventing element insures the frictional connection of the expansion sleeve with the borehole wall even when the borehole has a variable diameter, without noticeably increasing the resistance to the setting of the fastening element. Advantageously, the rotation-preventing element is provided in a section of the expansion sleeve that forms an axial extension of the at least one bead.

Advantageously, the at least one rotation-preventing element is provided in a circumferential region between the end of the at least one bead adjacent to the end of the elongate slot and the adjacent end of the elongate slot. The expansion of the expansion region, which is formed by the expansion tabs, in this case, is not influenced by the at least one rotation-preventing element, i.e., the rotation-preventing element does not hinder the expansion of the expansion tabs.

Advantageously, the at least one rotation-preventing element is formed by a projecting radially outwardly, wall section of the expansion sleeve. The wall section is advantageously stamped out of the wall of the expansion sleeve at three sides and is bent outwardly, with the distance of the wall section to the expansion sleeve outer wall increasing in a direction opposite the setting direction. Alternatively, the at least one rotation-preventing element can be formed as a projection that extends past the axial projection of the expansion sleeve in some regions.

Advantageously, each of the expansion tabs is provided with at least one bead. Thereby, the expansion sleeve has an advantageous stiffness over its entire expansion region.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a fastening element according to the present invention; and

FIG. 2 a cross-sectional view of the expansion sleeve of the fastening element shown in FIG. 1 along line 11-II in FIG. 1.

### DETAILED DESCRIPTION OF THE PREFERRED EMBODIMENT

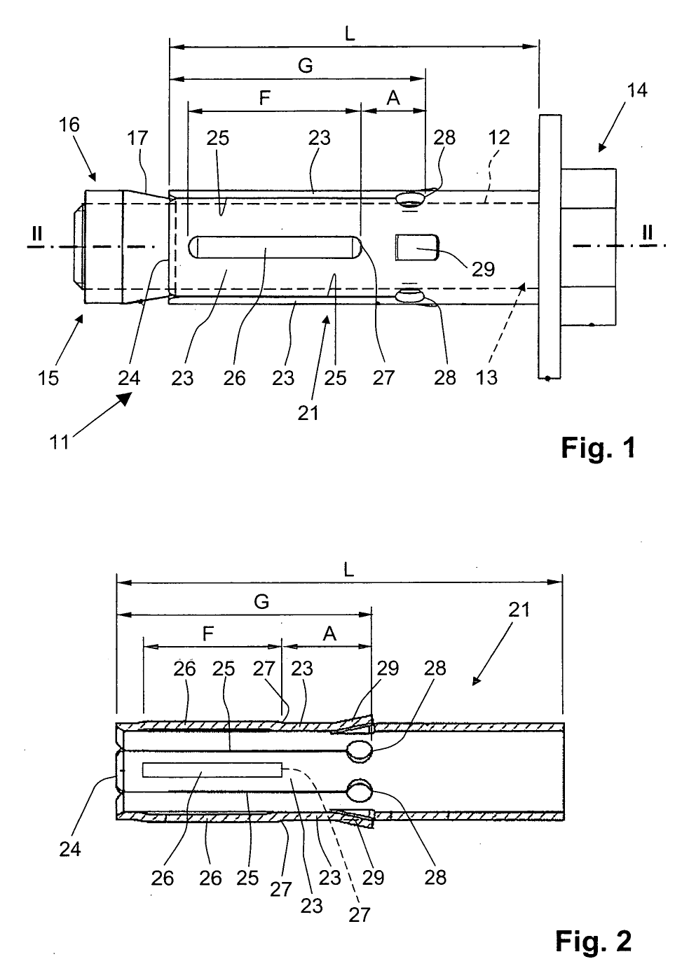

A fastening element 11, which is designed for being anchored in a borehole of a constructional component and which is shown in FIGS. 1-2, has a shaft 12 and an expansion sleeve 21 mounted on the shaft 12 and surrounding the same. The shaft 12 has, at its first end region 13, engagement means 14 in form of rotation-transmitting means that is designed to cooperate with a setting tool and is supported against a washer press-mounted on the shaft 12. In its second end region 15 opposite the first end region 13, the shaft 12 is provided with an expansion portion 16 for expanding the expansion sleeve 21. The expansion portion 16 has a conical section 17 that expand toward the free end of the second end region 15 of the shaft 12.

The expansion sleeve 21 has a plurality of expansion tabs 23 which are separated by elongate slots 25 extending from the free end 24 of the expansion sleeve 21 over at least a half of the longitudinal extent L of the expansion sleeve 21. On each of the expansion tabs 23, there is provided a bead 26 a longitudinal extent F of which between respective longitudinal slots 25 corresponds at least to a half of the longitudinal extent G of the elongate slot 25. The beads 26 circumferentially widen the expansion sleeve 21, i.e., widen it radially outwardly. For opening of the elongate slots 25 at the free end 24 of the expansion sleeve 25, the ends 27 of the beads 26 adjacent to the ends 28 of the elongate slots 25 remote from the free end 24 of the expansion sleeve 21, are spaced from the slot ends 28 in the direction of the free end 24 by a distance A. In the axial projection of each bead 26 and in the circumferential region between the end 27 of a respective bead 26 and the end 28 of the respective slot 25, there is provided a rotation-preventing element 29. The rotation-preventing element 29 is formed by a projecting radially outwardly, wall section of the expansion sleeve 21.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A fastening element for being anchored in a borehole of a constructional component, comprising a shaft (12) having, at a first end region (13) thereof engagement means (14); and an expansion sleeve (21) surrounding the shaft (12) and having a plurality of expansion tabs (23) spaced from each other by elongate slots (25) extending from a free end (24) of the expansion sleeve (21) over at least a half of a longitudinal extent (L) of the expansion sleeve (21) and having at least one bead (26) a longitudinal extent (F) of which corresponds to at least a half of a longitudinal extent (G) of the elongate slot (25), the shaft (12) having, in a second end region (15) thereof opposite the first end region (13) thereof, an expansion portion (16) for widening the expansion sleeve (21) and including a conical section (17) widening toward a free end of the second end region (15) of the shaft (12).

2. A fastening element according to claim 1, wherein the at least one bead (26) widens the expansion sleeve (21) circumferentially.

3. A fastening element according to claim 1, wherein an end (27) of the at least one bead (26) adjacent to an end (28) of a respective elongate slot (25) is spaced therefrom in a direction of opening of the elongate slot (25) at the free end (24) of the expansion sleeve (21) to provide for opening of the elongate slot (25) thereat.

4. A fastening element according to claim 3, wherein a least one rotation-preventing element (29) is provided in an axial projection of the at least one bead (26).

5. A fastening element according to claim 4, wherein the at least one rotation-preventing element (29) is provided in a circumferential region between the end (27) of the at least one bead (26) adjacent to the end (28) of the elongate slot (25) and the adjacent end (28) of the elongate slot (25).

6. A fastening element according to claim 4, wherein the at least one rotation-preventing element (29) is formed by a projecting radially outwardly, wall section of the expansion sleeve (21).

7. A fastening element according to claim 1, wherein each of the expansion tabs (23) is provided with at least one bead (26).
